(19) United States
(12) Patent Application Publication
(10) Pub. No.: US 2013/0250384 A1
(43) Pub. Date: Sep. 26, 2013

(54) LIGHT SCANNING MIRROR DEVICE, CONTROL METHOD FOR THE SAME, AND AN IMAGE DRAWING DEVICE EMPLOYING THE SAME

(71) Applicant: HITACHI MEDIA ELECTRONICS CO., LTD., Oshu-shi (JP)

(72) Inventors: Akira KOIDE, Inashiki-shi (JP); Norio HOSAKA, Yokohama-shi (JP)

(21) Appl. No.: 13/789,716

(22) Filed: Mar. 8, 2013

(30) Foreign Application Priority Data
Mar. 22, 2012 (JP) 2012-065766

(51) Int. Cl. G02B 26/10

(52) U.S. Cl. CPC G02B 26/105
USPC 359/200.6

(57) ABSTRACT

A light scanning mirror device is provided, which can be improved low power consumption, low voltage, small size, and a large scanning angle. The light scanning mirror device comprises a reflective mirror; and a torsion beam connecting the reflective mirror with a frame structure so as to enable the reflective mirror to rotate around an axis; a pair of cantilevers arranged perpendicular to the axis of rotation of the reflective mirror, and in axial symmetry centering on the axis of rotation; and a fixed electrode arranged oppositely to the cantilever in parallel at rest. The fixed electrode comprises an adsorptive fixed electrode on the free end side of the cantilever, and a rotation controlling fixed electrode on the fixed end side of the cantilever. The cantilever, the adsorptive fixed electrode, and the rotation controlling fixed electrode are configured to be separated electrically with each other.

The present application claims priority from Japanese application serial no. 2012-65766, filed on Mar. 22, 2012, the content of which is hereby incorporated by reference into this application.

### FIELD OF THE INVENTION

The present invention relates to a light scanning mirror device for scanning an optical beam, in particular, to a light scanning mirror device which is suitable to be mounted in an image drawing device such as a portable projector, and furthermore, to a control method of the light scanning mirror device and an image drawing device which employs the light scanning mirror device.

### BACKGROUND OF THE INVENTION

As disclosed by Japanese Patent No. 4490019 cited below and in the same manner as in a cathode-ray tube television which draws an image by scanning an electron beam horizontally and vertically in accordance with a picture signal, a light scanning mirror device draws an image by scanning a laser light horizontally and vertically in accordance with a picture signal. In particular, the light scanning mirror device has attracted attention as a key device of the image drawing device, such as a head mounted display, a micro projector, etc., which can display an image regardless of location.

The image drawing device comprises an optical system with the combination of a laser light and a light scanning mirror device, and an image signal processing circuit. Owing to the utilization of a laser light, it has the features such as (1) reduction in size of the optical system and (2) no necessity of focusing. The image drawing device has an advantage that image drawing on a curved surface is also possible. Therefore, it is possible to consider various applications combined with the portable information device, such as an enlarged projection of information which is illegible on a small liquid crystal display of a mobile device, and employment for a presentation in a place away from the office.

As disclosed by Japanese Patent No. 4515029 cited below, the light scanning mirror device is required to support the scanning frequency of 10 kHz or higher for horizontal scanning and several tens of Hz for vertical scanning, from the viewpoint of the number of the scanning lines which form a screen. In particular, in the latter vertical scanning, velocity control is performed in order to draw the horizontal scanning lines at a constant interval. In general, the drive of a light scanning mirror device is performed by rotating a reflective mirror through the use of the Lorentz force induced to a current in a magnetic field. Accordingly, resonant drive is applied to the horizontal scanning driven at a high frequency of 10 kHz or higher. On the other hand, nonresonant drive is applied to the vertical scanning which needs to be controlled to keep a uniform velocity during the drawing of horizontal scanning lines.

As described above, the image drawing device has the merit that it is possible to perform enlarged drawing of an image, regardless of location. Accordingly, the application as a portable device is considered in particular, requiring low power consumption and small size. For example, in an image drawing device of the electromagnetic drive type which develops large heat loss, it is required to attain reduction of the power consumption (low power consumption) and reduction of the implementation size including a magnet.

On the other hand, from the trend of the product, improvement in the magnifying power of an image (ratio of the distance to a projection plane to a screen size), prevention of deterioration in the image quality of an enlarged screen, etc. are required. Therefore, it becomes necessary to realize a high frequency of the scanning speed and the enlargement of the scanning angle. This will lead to increase of the power consumption, or enlargement of the size of a magnet.

Therefore, for example, Published Japanese Translation of PCT International Publication No. 2011-517626 cited below examines a light scanning mirror device of an electrostatic driving type as a means to reduce the power consumption of the light scanning mirror device, and discloses a resonant drive in vacuum, as a method for obtaining a large scanning angle at a low voltage. In the light scanning mirror device disclosed by Published Japanese Translation of PCT International Publication No. 2011-517626, there is no issue in particular concerning the horizontal scanning. However, the resonant drive disclosed herein cannot support the constant velocity control required for the vertical scanning during the drawing of horizontal scanning lines. Therefore, it becomes necessary to adopt the nonresonant drive.

In addition, in the electrostatic driving for rotating a reflective mirror by the nonresonant drive, a method for enlarging the scanning angle at a low voltage is already disclosed by Published Japanese Unexamined Patent Application No. 2008-172902 cited below, for example. The light scanning mirror device disclosed by Published Japanese Unexamined Patent Application No. 2008-172902 comprises a movable electrode substrate which can move only in the up-and-down direction in which a large number of vertical holes are open, and a fixed electrode which stands straight in parallel to the wall surface of each vertical hole of the movable electrode substrate and has a height lower than the height of the vertical hole. In the present configuration, the movable electrode substrate is translated downward by the power developed to reduce the difference in the height direction when a voltage difference is applied between the electrodes.

The rotation of the reflective mirror is attained by a torque given to the reflective mirror when the position connecting the movable electrode substrate and the reflective mirror is shifted from the axis of rotation of the reflective mirror. However, in the present system, the torque is given only in one direction to the reflective mirror; accordingly, distortion developed in the torsion beam supporting the reflective mirror becomes twice, compared with the reflective mirror of the electromagnetic drive type which rotates in both directions. When the scanning angle is enlarged, it is necessary to enlarge the area of the movable electrode substrate.

The present invention has been made in view of the subject in the related art technology described above, and realizes a light scanning mirror device which has improved the performance, without sacrificing any required properties described above, such as reduced power consumption, low voltage driving, reduction in size, and an enlarged scanning angle. That is, the present invention aims at providing an excellent light scanning mirror device and its control method, and also providing an image drawing device which utilizes the light scanning mirror device concerned.

### SUMMARY OF THE INVENTION

In order to solve the subject, the present invention adopts the configuration described in the scope of the following claims. That is, the present invention provides a reflective mirror device which comprises at least a reflective mirror and a torsion beam which is connected to a frame structure and enables the reflective mirror to rotate around at least one axis. In the reflective mirror device, there are at least a couple of cantilevers arranged in the horizontal plane of the reflective mirror and in axial symmetry centering on the axis of rotation, in the perpendicular direction to the axis of rotation, and a fixed electrode which stands in parallel facing the cantilever at rest, in the movement direction of the cantilever rotating around the axis of rotation. The fixed electrode has, to one cantilever, at least an adsorptive electrode on the side of the free end of the cantilever and a controlling electrode on the side of the fixed end of the cantilever, respectively. The cantilever, the adsorptive electrode, and the controlling electrode are electrically separated mutually. According to the present configuration, in the first process, a voltage is applied between the cantilever and the adsorptive electrode, and the free end side of the cantilever is accordingly fixed to the adsorptive electrode by use of a static electricity power; in the second process, a voltage is applied to the controlling electrode in the state where the free end of the cantilever is in contact with the adsorptive electrode and where the space between the controlling electrode and the cantilever changes from a narrow area on the side of the free end of the cantilever to a broad area on the side of the fixed end of the cantilever, and the cantilever is accordingly adsorbed to the controlling electrode from the area where the space between the controlling electrode and the cantilever is narrow, as the voltage applied to the controlling electrode is gradually increased from zero. Accordingly, a torque is generated around the axis of rotation by the adsorption power to rotate the reflective mirror device, and the scanning speed of the light scanning mirror device is controlled arbitrarily.

Specifically, in order to attain the purpose described above, the present invention provides a light scanning mirror device which comprises a movable electrode substrate and a fixed electrode substrate arranged oppositely to the movable electrode substrate in a laminated manner. The movable electrode substrate comprises in one substrate at least a reflective mirror, a frame unit enclosing the outer circumference of the reflective mirror, a torsion beam formed in a body connecting the reflective mirror and the frame unit so as to enable the reflective mirror to rotate around at least one axis, and a movable electrode attached to a part of the reflective mirror. The fixed electrode substrate comprises in one substrate a fixed electrode arranged oppositely to the movable electrode. In the light scanning mirror device, the movable electrode of the movable electrode substrate is a cantilever movable electrode provided with at least a couple of cantilevers arranged in axial symmetry centering on the one axis. The fixed electrode of the fixed electrode substrate comprises an adsorptive fixed electrode which adsorbs and fixes an electrode on the side of a free end of the cantilever movable electrode, and a rotation controlling fixed electrode which adsorbs the cantilever movable electrode and controls rotation of the reflective mirror. The adsorptive fixed electrode and the rotation controlling fixed electrode are separated electrically with each other.

According to the present invention, in the light scanning mirror device described above, it is preferable that the adsorptive fixed electrode of the fixed electrode substrate is arranged in the position distant from the rotation controlling fixed electrode with respect to the one axis. It is also preferable that a substrate which is transparent at least at a part corresponding to the reflective mirror is further laminated over a surface of the movable electrode substrate different from the surface facing the fixed electrode substrate laminated, so as to accomplish hermetic sealing of the reflective mirror. In addition, it is preferable that a through-hole electrode is formed in a part of the fixed electrode substrate, in order to electrically couple the movable electrode of the movable electrode substrate, and the adsorptive fixed electrode and the rotation controlling fixed electrode of the fixed electrode substrate, to the exterior of the light scanning mirror device.

According to the present invention, in the light scanning mirror device described above, it is preferable that the movable electrode substrate further comprises a second movable electrode different from the movable electrode, provided in axial symmetry centering on the one axis, and that the fixed electrode substrate further comprises a second rotation controlling fixed electrode arranged oppositely to the second movable electrode. It is also preferable that an insulating film with protrusions is provided over at least one of the contacting surfaces of the cantilever movable electrode and the fixed electrode. It is further preferable that an element for measuring a rotation angle of the reflective mirror is built in a part of the reflective mirror.

In order to attain the purpose described above as well, the present invention provides a control method of the light scanning mirror device described above, as follows. A voltage is applied between the cantilever movable electrode and the adsorptive fixed electrode to generate a static electricity power. By use of the static electricity power, the free end of the cantilever movable electrode is adsorbed and fixed to the adsorptive fixed electrode, and the cantilever movable electrode is kept in a state of being changeable from a narrow area on the side of the free end to a broad area on the side of the rotation controlling fixed electrode. The cantilever movable electrode is adsorbed to the rotation controlling fixed electrode, by changing gradually the voltage applied to the rotation controlling fixed electrode to generate an adsorption power. Accordingly, by use of the adsorption power, a torque to rotate the reflective mirror around the one axis is generated, and the reflective mirror is rotated.

Furthermore, the present invention provides an image drawing device which comprises at least a light source for emitting a beam-shaped light and a reflective mirror for reflecting the beam-shaped light emitted from the light source, and which draws an image by reflecting and scanning the beam-shaped light, by means of the reflective mirror. The image drawing device employs one of the light scanning mirror devices described above, for use as the reflective mirror.

According to the present invention, the configuration described above can provide, as the excellent effect, the light scanning mirror device which is an electrostatic driving type of low power consumption and which can rotate the reflective mirror at a low voltage, even for a large scanning angle, and also can provide the control method of the light scanning mirror device and the image drawing device which utilizes the light scanning mirror device.

### BRIEF DESCRIPTION OF THE DRAWINGS

FIGS. 1A and 1B illustrate an example of the configuration of a light scanning mirror device according to Embodiment 1 of the present invention, in which FIG. 1A illustrates a top view and FIG. 1B illustrates an A-A sectional view;

FIG. 2 is an A-A sectional view illustrating an example of a drive method of the light scanning mirror device, in which, a state (A) illustrates an initial state of the light scanning mirror device, a state (B) illustrates a formed state of an inclined electrode of the light scanning mirror device, a state (C) illustrates a start state of a counter clockwise rotation of the light scanning mirror device, a state (D) illustrates an end state of the counter clockwise rotation of the light scanning mirror device, a state (E) illustrates a start state of a clockwise rotation of the light scanning mirror device, a state (F) illustrates a rotation state (1) of the clockwise rotation of the light scanning mirror device, a state (G) illustrates a rotation state (2) of the clockwise rotation of the light scanning mirror device, a state (H) illustrates an end state of the clockwise rotation of the light scanning mirror device, a state (I) illustrates a start state of the counter clockwise rotation of the light scanning mirror device, and a state (J) illustrates a rotation state of the clockwise rotation of the light scanning mirror device, respectively;

FIG. 3 is a drawing illustrating an example of a drive voltage of the light scanning mirror device, in which a voltage (A) illustrates an applied voltage to an adsorptive fixed electrode, a voltage (B) illustrates an applied voltage to a rotation controlling fixed electrode 102-4, and a voltage (C) illustrates an applied voltage to a rotation controlling fixed electrode 102-2;

FIGS. 4A, 4B, and 4C are drawings illustrating an example of processing procedure of a movable electrode substrate of the light scanning mirror device, in which FIG. 4A illustrates the substrate cross section at the initial state, FIG. 4B illustrates the substrate cross section after the first processing, and FIG. 4C illustrates the substrate cross section after the second processing;

FIGS. 5A, 5B, and 5C are drawings illustrating an example of processing procedure of a fixed electrode substrate of the light scanning mirror device, in which FIG. 5A illustrates the substrate cross section at the initial state, FIG. 5B illustrates the substrate cross section after the first processing, and FIG. 5C illustrates the substrate cross section after the second processing;

FIGS. 6A and 6B are drawings illustrating an example of the configuration of a light scanning mirror device to which hermetic sealing is accomplished, according to Embodiment 2 of the present invention, in which FIG. 6A illustrates a top view and FIG. 6B illustrates an A-A sectional view;

FIG. 7A and FIG. 7B are drawings illustrating an example of the configuration of a light scanning mirror device according to Embodiment 3 of the present invention, in which FIG. 7A illustrates a top view and FIG. 7B illustrates a B-B sectional view;

FIG. 8 is a top view illustrating an example of the configuration of a biaxial-type light scanning mirror device according to Embodiment 4 of the present invention; and

FIG. 9 is a block diagram illustrating an example of the configuration of an image drawing device utilizing the light scanning mirror device, according to Embodiment 5 of the present invention.

### DETAILED DESCRIPTION OF THE PREFERRED EMBODIMENTS

Hereinafter, with reference to the accompanying drawings, the embodiments of the present invention are explained in detail.

### Embodiment 1

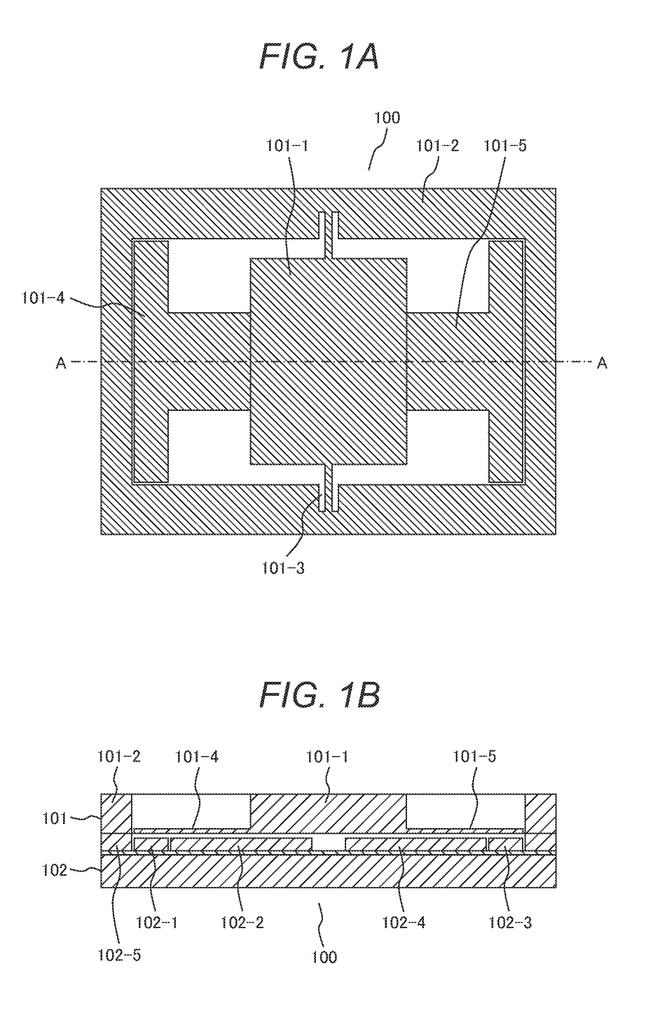

First, with reference to FIGS. 1A-5C, a first embodiment (Embodiment 1) of the present invention is explained. The present embodiment describes a light scanning mirror device 100 which scans light by use of a reflective mirror.

FIGS. 1A and 1B are a top view and an A-A sectional view, respectively, illustrating the configuration of the light scanning mirror device 100 of the present embodiment. In FIGS. 1A and 1B, the light scanning mirror device 100 comprises a movable electrode substrate 101 and a fixed electrode substrate 102 (refer to FIG. 1B), which are laminated in the so-called two-layer structure. In further detail, as clearly shown in FIG. 1A, the movable electrode substrate 101 is composed of a reflective mirror 101-1 and a frame unit 101-2, and the reflective mirror 101-1 is provided with a pair of torsion beams 101-3 connected with the frame unit 101-2 so that the reflective mirror 101-1 can rotate only around one axis. In addition, the reflective mirror 101-1 is further provided with cantilever movable electrodes 101-4 and 101-5 which are arranged in axial symmetry to the axis of rotation formed by the torsion beams 101-3. Although not described here, it is preferable to provide a distortion isolating structure, in order to reduce the influence of distortion developed in the longitudinal direction of the cantilever movable electrodes 101-4 and 101-5.

On the other hand, the fixed electrode substrate 102 is provided with a frame unit 102-5 for assembling by bonding to the frame unit 101-2 of the movable electrode substrate 101. In addition, an adsorptive fixed electrode 102-1 and a rotation controlling fixed electrode 102-2 are arranged, in a position horizontally opposing the cantilever movable electrode 101-4 on one side when assembled with the movable electrode substrate 101, and an adsorptive fixed electrode 102-3 and a rotation controlling fixed electrode 102-4 are arranged, in a position horizontally opposing the cantilever movable electrode 101-5 on the other side. The adsorptive fixed electrode 102-1, the rotation controlling fixed electrode 102-2, the adsorptive fixed electrode 102-3, and the rotation controlling fixed electrode 102-4 are separated electrically with each other. Here, wirings to each of the electrodes described above are not shown.

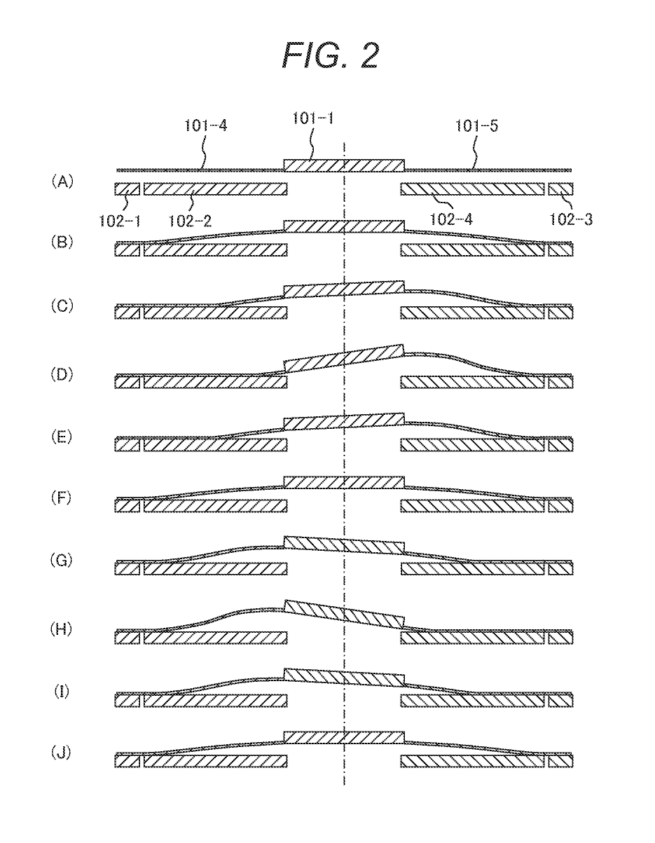

Next, operation of the light scanning mirror device 100, of which the detailed structure is explained in the above, is explained in detail with reference to FIG. 2. FIG. 2 illustrates the A-A cross section in FIGS. 1A and 1B, and in particular, explains the procedure of rotating the reflective mirror 101-1, based on changes of the shape according to the rotation of the reflective mirror 101-1. The rotation of the reflective mirror 101-1 is accomplished by the following procedure.

First, in an initial state (A), a voltage is applied between the cantilever movable electrodes 101-4 and 101-5 and the adsorptive fixed electrodes 102-1 and 102-3, then by the static electricity power developed between these electrodes, the tips on the free end side of the cantilever movable electrodes 101-4 and 101-5 are moved to the state (B) where the tips are adsorbed and fixed to the adsorptive fixed electrodes 102-1 and 102-3, respectively. It is so configured that, in the state (B), the electrode spacing between the rotation controlling fixed electrodes 102-2 and 102-4 and the cantilever movable electrodes 101-4 and 101-5 becomes wider gradually from the narrow area on the side of the free end of the cantilever movable electrodes 101-4 and 101-5 to the broad area on the side of the fixed end. An insulating film is formed on either of the surfaces of the movable electrode and the fixed electrode so that the electrodes may not be short-circuited. However, when electrons accumulate in the insulating film, the dynamic characteristics as the electrostatic actuator will be affected. Accordingly, it is preferable to adopt the structure of suppressing the influence due to electrification, by arranging the insulating film in the shape of small protrusions, for example, thereby reducing the total amount of electrons accumulated.

From the state (B), when a voltage is further applied between the cantilever movable electrode 101-4 and the rotation controlling fixed electrode 102-2, the static electricity power, which is in inverse proportion to the square of the spacing between the electrodes, acts strongly in the area where the spacing between the electrodes is narrow. Accordingly, the cantilever movable electrode 101-4 adsorbs to the rotation controlling fixed electrode 102-2, gradually from the free end side. The position at which this adsorption stops is given by a position where the reaction force from the fixed end of the cantilever movable electrode 101-4 balances with the electrostatic attraction from the free end, by the intermediary of the cantilever movable electrode deformed in response to the electrostatic attraction. Consequently, when the voltage applied between the electrodes is increased, the adsorption position moves to the direction of the axis of rotation of the reflective mirror 101-1. The change of the absorption position applies a torque which rotates the reflective mirror 101-1 counter clockwise centering on the axis of rotation 101-3. Therefore, the state shifts from the state (C) to the state (D).

On the other hand, the clockwise rotation from the state (D) at which the rotation has reached the extreme in the counter clockwise direction (the rotation at the maximum angle) is started by reducing the voltage which has been applied between the cantilever movable electrode 101-2 and the rotation controlling fixed electrode 102-2 to zero, and applying a voltage between the cantilever movable electrode 101-5 and the rotation controlling fixed electrode 102-4. Accordingly, the state is shifted from the state (D) to the state (H), as is the case with the procedure in the counter clockwise rotation described above.

The shift from the state (H) to the state (J), and furthermore, the shift from the state (B), which is equivalent to the state (J), to the state (D) are the same repetition as the shift in the counter clockwise rotation described above. By repeating the procedure from the state (B) to the state (J) described above, the reflective mirror device makes the desired rotation, that is, the reflective mirror device functions as the light scanning mirror device.

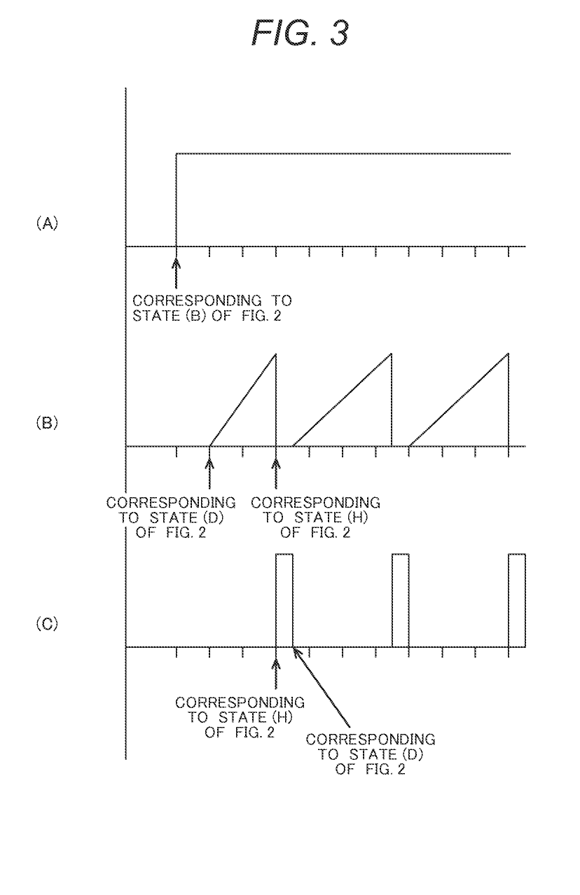

Next, FIG. 3 illustrates an example of voltage applied when the light scanning mirror device according to the present invention is employed for the vertical scanning in image drawing, in particular. The examples are illustrated for the voltage (A) applied to the adsorptive fixed electrodes 102-1 and 102-3, the voltage (B) applied to the rotation controlling fixed electrode 102-4, and the voltage (C) applied to the rotation controlling fixed electrode 102-2. Here, it is assumed that the cantilever movable electrode is grounded.

Here, referring to FIG. 2 as well, in the interval of the constant velocity control of the vertical scanning during the horizontal scanning lines are drawn, the light scanning mirror device shifts from the state (D) to the state (H), as illustrated in FIG. 2. From the state (H) when drawing the horizontal scanning lines of one screen is completed, up to the state (D) when drawing the horizontal scanning lines of the next screen is started, the reflective mirror is returned at a stroke, such that from the state (H) to the state (I), to the state (B) (equivalent to the state (J)), to the state (C), and to the state (D) (refer to the waveforms of the voltages (A) and (C) illustrated in FIG. 3).

In the vertical scanning when drawing the horizontal scanning lines from the top to the bottom, the voltage applied to the rotation controlling fixed electrode 102-4 is gradually increased from the position of the state (D) (refer to the waveform of the voltage (B) illustrated in FIG. 3).

The applied voltage here is determined by the balance of the static electricity power (increasing in proportion to the square of the applied voltage) which develops in the non-adsorption part of the cantilever movable electrode 101-5 and the free end side of the rotation controlling fixed electrode 102-4, with the distance from the adsorption position to the axis of rotation and the reaction force from the torsion beam. The manner in which the voltage applied to the rotation controlling fixed electrode 102-4 is increased is determined uniquely by the reaction force due to the torsional rigidity of the torsion beam 101-3 and the magnitude of the torque applied to the torsion beam 101-3 of the reflective mirror 101-1 from the cantilever movable electrode 101-4. However, it is also possible to set the inclined part, not as a straight line like the voltage applied to the rotation controlling fixed electrode 102-4 as illustrated in the voltage (B) of FIG. 3, but as a curve of which the increasing rate of voltage becomes larger as the rotation angle becomes larger. As described above, when the scanning speed becomes unstable under the influence of charge of the insulating film, etc., it is preferable to apply voltage also to the rotation controlling fixed electrode 102-2, and to decrease the voltage gradually in contrast with the rotation controlling fixed electrode 102-4. However, usually, no voltage is applied to the rotation controlling fixed electrode 102-2.

As a method for performing the velocity control of the vertical scanning to high accuracy, there is a method in which a sensor for detecting the rotation angle of the reflective mirror is built in the light scanning mirror device, and a detected voltage corresponding to the rotation angle is applied to the rotation controlling fixed electrode 102-4, to control the scanning speed. For the detection of the rotation angle in such a case, it will be possible to adopt, for example, a method in which a piezoresistive element is built in the torsion beam 101-3 and the distortion of the torsion beam developed due to rotation is measured from a Wheatstone bridge circuit, thereby the rotation angle is estimated, a method in which an electrostatic capacity sensor is provided in the reflective mirror 101-1 and the tilting angle of the reflective mirror is measured directly, and others.

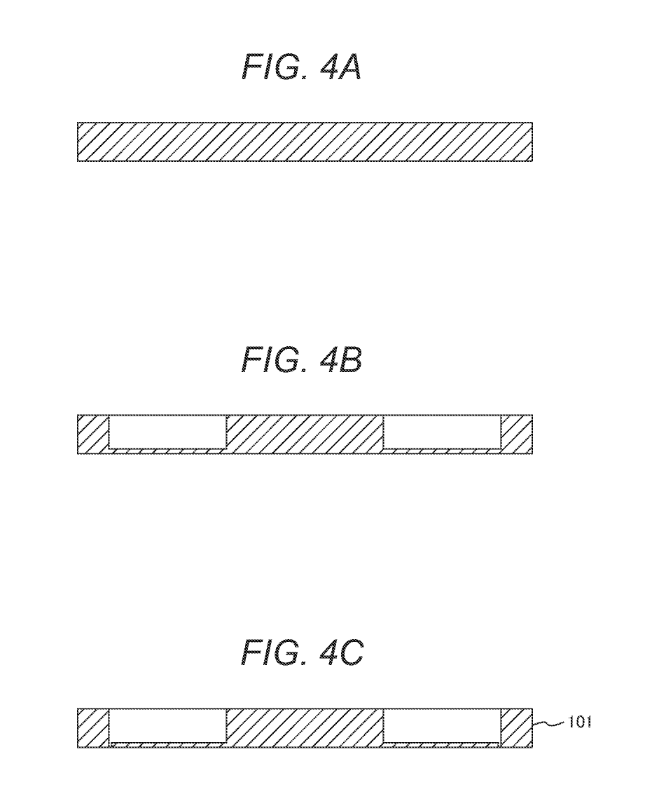

Next, the following explains an example of the processing method of the movable electrode substrate and the fixed electrode substrate of the light scanning mirror device described above. FIGS. 4A, 4B, and 4C illustrate the processed cross sections (corresponding to the A-A cross section of FIG. 1A) of the movable electrode substrate 101 of the light scanning mirror device according to the present embodiment.

The movable electrode substrate is manufactured using a single crystal silicone substrate or a SOI (Silicon On Insulator) substrate. The present embodiment exemplifies the case where the former single crystal silicone substrate is employed. FIG. 4A illustrates a cross section of a single crystal silicone substrate, and FIG. 4B illustrates the shape of the cross section after a diaphragm having the thickness of the cantilever movable electrode is formed by dry etching. In the present processing, not only dry etching but other methods such as wet etching may be used for the processing. From the viewpoint of the accuracy of the thickness of the diaphragm in particular, wet etching is superior to dry etching. However, the reason for employing dry etching in the present embodiment lies in the fact that it is easier to control the shape of the reflective mirror after the processing. When high accuracy is required in processing the thickness of the cantilever movable electrode in particular, it is only necessary to employ a SOI substrate with the active layer of the same thickness and to process the cantilever movable electrode by applying the etching stop in a BOX (buried oxide) layer.

The shape of the processed cross section of FIG. 4C illustrates the shape of the cross section after the so-called cut-through process is performed from the opposite side of the surface on which the diaphragm has been processed, so that the cantilever movable electrode can be separated from the circumference. Also in the present processing, it is possible to employ either dry etching or wet etching. However, there are different points to notice in each case. First, in dry etching, when applying the etching stop in a BOX layer, the shape failure called a notch may occur. Accordingly, it is important to perform the processing under the processing conditions not inducing such a phenomenon. On the other hand, in wet etching, the shape failure may occur at convex-shaped corners of the cantilever movable electrode or the reflective mirror. Therefore, some measures become necessary to be taken, such that an additive is mixed with an etching solution or a compensation mask is attached, in order to prevent the occurrence of such defectives. Both techniques are already established as mass production techniques; therefore, it is understood that the present embodiment is easily feasible.

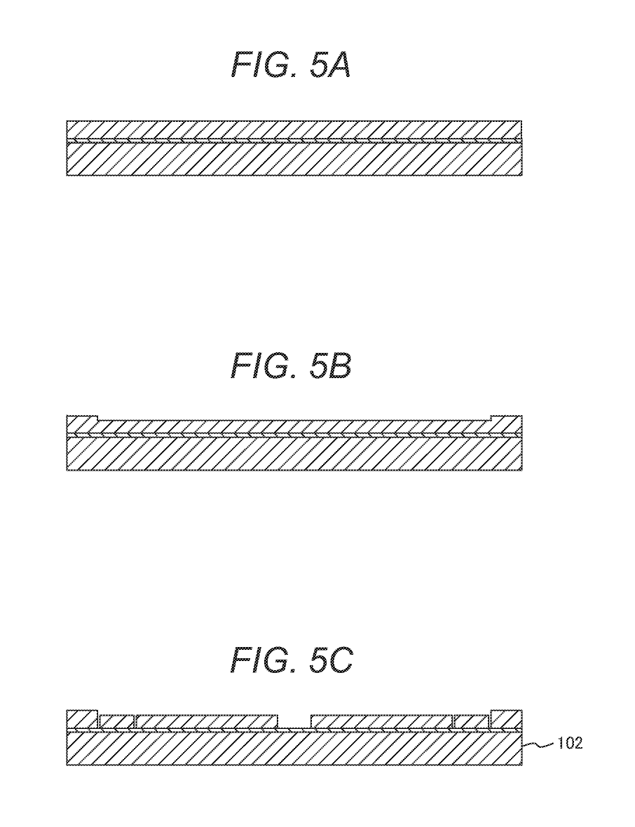

FIGS. 5A, 5B, and 5C illustrate the processed cross section (corresponding to the A-A cross section of FIG. 1A) of the fixed electrode substrate 102 in the light scanning mirror device according to the present embodiment. The fixed electrode substrate 102 is manufactured using a SOI (Silicon On Insulator) substrate. FIG. 5A illustrates the cross section of the SOI substrate, and FIGS. 5B and 5C illustrate the shape of the cross section after processing. The present processing is performed by applying wet etching. The reason lies in the fact that the present step is important processing which determines the electrode spacing between the movable electrode and the fixed electrode, therefore the wet etching which is excellent in the processing accuracy in the depth direction is employed. However, dry etching is employed for processing of the shape of the cross section illustrated in FIG. 5C. It is possible to employ wet etching also in the present processing. The reason and other details are the same as in the processing of the movable electrode substrate; therefore, the description thereof is omitted here.

### Embodiment 2

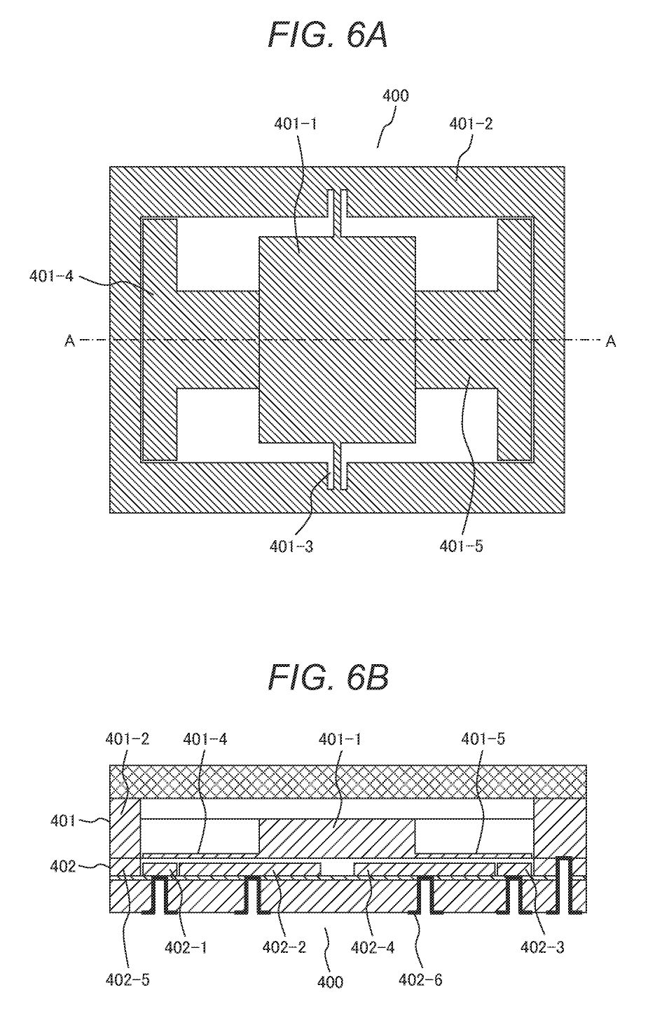

Next, the following explains the second embodiment (Embodiment 2) according to the present invention, with reference to FIGS. 6A and 6B. The present embodiment relates to a light scanning mirror device 400 in which a cap substrate 403 through which a laser light passes is further laminated over the two-layer structure according to Embodiment 1, so as to accomplish hermetic sealing of the reflective mirror.

That is, in the so-called contact accompanying actuator, such as the inclined electrode type electrostatic actuator which is formed by adsorbing and fixing the cantilever movable electrodes 401-4 and 401-5 to the adsorptive fixed electrodes 402-1 and 402-3, the malfunction caused by peripheral environment occurs, such as sticking of a contact portion due to molecules floating in the atmosphere (such as humidity and volatile organic matter), and the stoppage of the proper operation caused by dust intruded into the spacing of the electrodes. Therefore, in the present embodiment, the cap substrate 403 is provided in the upper part of the movable electrode substrate 401, as clearly seen from FIGS. 6A and 6B. The cap substrate 403 protects (seals) the electrostatic actuator for rotating the reflective mirror from the peripheral environment (atmosphere) as a cause of malfunction. Here, the electrostatic actuator comprises the reflective mirror 401-1, the cantilever movable electrodes 401-4 and 401-5, the adsorptive fixed electrodes 402-1 and 402-3, and the rotation controlling fixed electrodes 401-2 and 401-4. Accordingly, the cap substrate 403 fulfills the role for maintaining the interior in a clean environment so that the light scanning mirror device 400 can continue a stable operation. The other constituent elements are the same as those of Embodiment 1, and the explanation thereof is omitted here.

The drive method of the light scanning mirror device 400 according to the present embodiment is also the same as that of Embodiment 1, and the explanation thereof is omitted here.

The hermetic sealing described above is performed by controlling the internal airtight pressure, through the employment of inert gas, such as nitrogen and argon, in the vacuum equipment, for example. The concrete methods of performing the hermetic sealing include, for example, a method for performing the hermetic sealing when the cap substrate is bonded, and a method for performing the hermetic sealing by making a leak hole at the time of bonding the cap substrate and subsequently filling up the leak hole in vacuum film deposition equipment.

When it is necessary to keep constant the pressure in the hermetic sealing space for the long term, it is possible to adopt measures in which a gas adsorption film is formed at a portion of the cap substrate 403 where the light does not pass. However, when such measures are not required but the pressure below a certain value is sufficient, it is possible to adopt simple measures in which the pretreatment is performed for removing molecules which are sticking to the part of the wall surface in the hermetic sealing space, before the hermetic sealing is made.

In the present embodiment, antireflection treatment by an antireflection film coating for example is made on the surface of the cap substrate 403 through which a laser light passes, so that the laser light may not reflect. At the time of hermetic sealing, a low temperature process is applied so that the function of the surface of the cap substrate may not be impaired. As the bonding method of the cap substrate at a low temperature, various methods are known, such as a method in which a pretreatment such as a film formation is performed so as to make a bonding interface have the same properties of material, and in which the surface concerned is activated in a high vacuum and bonded at a normal temperature, a method of fused bonding at about 200° C. using a low-melting glass and a eutectic crystal, and a method of anodic bonding at about 280° C. using Pyrex (registered trademark) glass. However, it is preferable to select the suitable method comprehensively from the viewpoints of temperature, bonding strength, airtightness, cost, etc., which does not impair the function of the processing for antireflection and antistatic treatment treated to the cap substrate.

In this way, according to Embodiment 2 of the present invention, it is possible to realize a stable light scanning without variation with time, by providing the hermetic sealing with the cap substrate 403 and thereby eliminating the influence of humidity and dust which exist in the peripheral environment. In that case, however, it is necessary to supply a power source into the hermetic sealing space. As wiring technology for that, it is possible to adopt the so-called side extraction electrode in which wiring is buried under the bonded surface of the substrate and the so-called through-hole electrode 402-6 as illustrated in FIGS. 6A and 6B, for example. In particular, the merit of employing the through-hole electrode 402-6 illustrated in FIGS. 6A and 6B lies in the point that miniaturization is possible because additional area (increase of area) of an electrode pad to the light scanning mirror device is not necessary, and furthermore in the point that an electrical connection with the exterior such as flexible wiring can be simplified by using an anisotropic conducting sheet, etc.

As already described, the causes of the malfunction of the electrostatic driving actuator, except for the peripheral environment, arise from the electrification phenomena in which electrons accumulate in an insulating film. With regard to the present matter, when coating an insulating film over the surface of the cantilever movable electrodes 402-4 and 402-5 and the surface of the rotation controlling fixed electrodes 402-2 and 402-4 for the prevention from short-circuiting as described above, not only by forming the insulating film in the shape of a film, but by forming the insulating film in the shape of small protrusions, it is also possible to reduce the total amount of electrons which accumulate on the insulating film, and to suppress the influence on the operation of the electrostatic driving actuator to the minimum.

### Embodiment 3

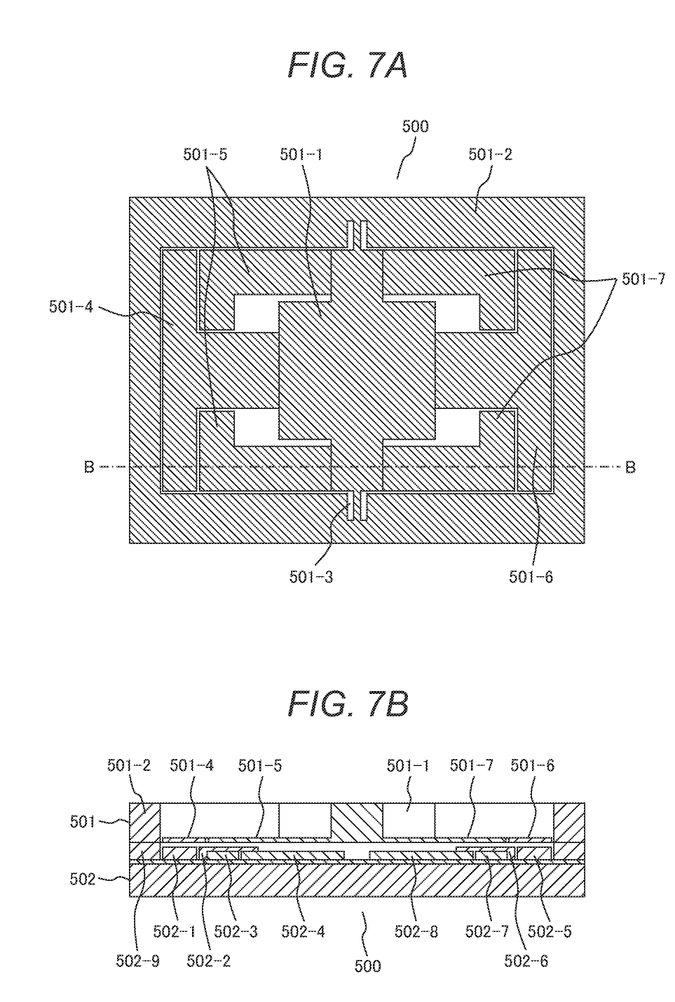

Next, the following explains the third embodiment (Embodiment 3) according to the present invention, with reference to FIGS. 7A and 7B. The present embodiment relates to a light scanning mirror device 500 which is configured appropriately in expanding the scanning angle in particular, based on the light scanning mirror device according to Embodiment 1 described above.

In FIGS. 7A and 7B illustrating the configuration of the light scanning mirror device 500 according to the present embodiment, the difference from Embodiment 1 lies in the following point. That is, the light scanning mirror device 500 comprises, as the cantilever movable electrode, the first cantilever movable electrodes 501-4 and 501-6 which have the same electrode spacing as ones in Embodiment 1 and, in addition, the second cantilever movable electrodes 501-5 and 501-7 which have a wider electrode spacing than ones in Embodiment 1, that is, two kinds of electrodes are adopted. The other constituent elements are the same as those of Embodiment 1, and the explanation thereof is omitted here.

In the configuration according to Embodiment 3 described above, the procedure of rotating the reflective mirror is the same as that in Embodiment 1, and the explanation thereof is omitted. However, the following explains the reason why it is possible to enlarge the rotation angle in particular.

In Embodiment 3, the reflective mirror 501-1 is first rotated by use of the first cantilever movable electrode 501-6. Accordingly, the second cantilever movable electrode 501-7 formed in a body with the reflective mirror 501-1 tilts similarly, and the electrode spacing between the electrode concerned and the second adsorptive fixed electrode 502-8 becomes narrow. Accordingly, the second cantilever movable electrode 501-7 as well as the first cantilever movable electrode 501-6 described above can be adsorbed and fixed at the second adsorptive fixed electrode 502-5 at a low voltage. Therefore, it becomes possible to control the rotation angle by the second rotation controlling fixed electrode 502-8. Here, two kinds of the cantilever movable electrodes 501-6 and 501-7 are employed; however, if the number is further increased, it is also possible to enlarge the scanning angle furthermore.

### Embodiment 4

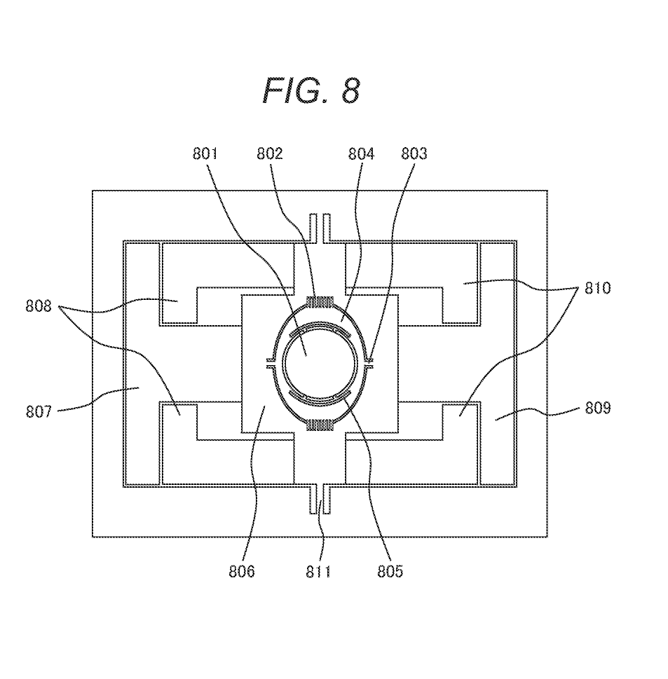

Furthermore, the following explains the fourth embodiment (Embodiment 4) according to the present invention, with reference to FIG. 8. In the present embodiment, the light scanning mirror device, which scans light by the reflective mirror, is changed from a uniaxial scan type to a biaxial scan type. The drive of the electrostatic driving actuator by use of the cantilever movable electrode and the rotation controlling fixed electrode according to the present embodiment is the same as that in Embodiment 1, therefore, the explanation thereof is omitted here.

FIG. 8 illustrates the configuration of a light scanning mirror device according to the present embodiment. In the figure, the light scanning mirror device according to the present embodiment is different from the light scanning mirror device 500 according to Embodiment 3 in the point that the light scanning mirror device according to the present embodiment is a resonance-type light scanning mirror device provided with the so-called resonance-type electrostatic driving actuator by use of a comb electrode in the portion of the reflective mirror 501-1 illustrated in FIG. 7A.

In the resonance-type light scanning mirror device, a reflective mirror 801 is fixed to a first scanning axis substrate 804 via a distortion isolating groove 805, and the first scanning axis substrate 804 is connected by use of a torsion beam 803 to a second scanning axis substrate 806. Then, the reflective mirror 801 is configured so as to be driven at a resonance frequency of a comb electrode 802 formed at an end of the first scanning axis substrate 804 in the direction of rotation. When the present resonance-type light scanning mirror device, i.e., the biaxial light scanning mirror device according to the present embodiment, is mounted in an image drawing device, such as a copy machine and a printer, for example, judging from each property, it will be preferable to apply the resonance-type light scanning mirror device to the horizontal scanning and to apply the light scanning mirror device by use of the cantilever movable electrode described above to the vertical scanning.

### Embodiment 5

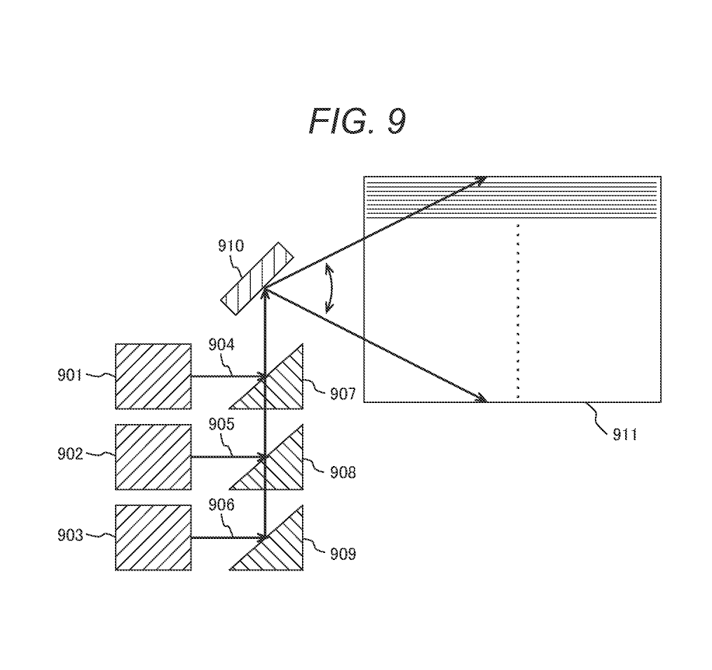

FIG. 9 explains an example of an image drawing device which employs the light scanning mirror device described above, as a fifth embodiment (Embodiment 5) of the present invention. That is, FIG. 9 illustrates an example of the configuration of the image drawing device which employs the light scanning mirror device, according to Embodiment 5.

In FIG. 9, the image drawing device comprises laser irradiation optical systems 901, 902, and 903, each provided with optical elements such as a lens, and a laser device composing a red, a green, and a blue light source, respectively. The laser lights 904, 905, and 906 irradiated from each optical system are condensed into the shape of a single line by reflective mirrors 907, 908, and 909 which reflect only a laser light of each color; accordingly, the laser lights of three colors are irradiated onto a light scanning mirror device 910 as a single laser beam. Then, by the laser beam reflected by the light scanning mirror device 910, an image is drawn on an image projection plane 911.

At this time, a desired image is drawn on the image projection plane 911 by synchronizing the scanning angle of the light scanning mirror device 910 and the picture signal. The feature of the image drawing device according to Embodiment 5 lies in the point that no optical system exists in the path of the light after the light scanning mirror device. Accordingly, it becomes possible to attain a focus-free drawing, and it becomes possible to project a well-focused image even on an image projection plane 911 with a curved surface. That is, owing to such features, various kinds of applications can be expected, for example, applications to an image drawing device of a portable projector, an image drawing device of a copy machine and a printer, and furthermore to a navigation system in which information is projected directly on a windshield of a vehicle, etc.

The light scanning mirror device according to the present invention can reduce the power consumption which used to be in the order of 100 mW in the electromagnetic drive in the related art to the order of several mW, owing to the structure described above. Therefore, even in the outdoors where a power source is not available, it becomes possible to project the information in an enlarged size for hours, by coupling to information equipment such as a mobile-phone, for example, and it is also possible to easily expand and display the detailed information which used to be difficult to be read on a small screen such as a liquid crystal display. Accordingly, it becomes possible to improve the level of convenience greatly.

What is claimed is:

1. A light scanning mirror device comprising:
a movable electrode substrate; and
a fixed electrode substrate arranged oppositely to the movable electrode substrate in a laminated manner,
wherein the movable electrode substrate comprises in one substrate at least
a reflective mirror;
a frame unit enclosing the outer circumference of the reflective mirror;
a torsion beam formed in a body connecting the reflective mirror and the frame unit so as to enable the reflective mirror to rotate around at least one axis; and
a movable electrode attached to a part of the reflective mirror,
wherein the fixed electrode substrate comprises in one substrate
a fixed electrode arranged oppositely to the movable electrode,
wherein the movable electrode of the movable electrode substrate is a cantilever movable electrode provided with at least a couple of cantilevers arranged in axial symmetry centering on the one axis, and
wherein the fixed electrode of the fixed electrode substrate comprises
an adsorptive fixed electrode operable to adsorb and fix an electrode at a free end of the cantilever movable electrode; and
a rotation controlling fixed electrode operable to adsorb the cantilever movable electrode and to control rotation of the reflective mirror, the adsorptive fixed electrode and the rotation controlling fixed electrode being separated electrically with each other.

2. The light scanning mirror device according to claim 1,
wherein the adsorptive fixed electrode of the fixed electrode substrate is arranged in the position distant from the rotation controlling fixed electrode with respect to the one axis.

3. The light scanning mirror device according to claim 2,
wherein a substrate which is transparent at least at a part corresponding to the reflective mirror is further laminated over a surface of the movable electrode substrate different from the surface facing the fixed electrode substrate laminated, so as to accomplish hermetic sealing of the reflective mirror.

4. The light scanning mirror device according to claim 3,
wherein a through-hole electrode is formed in a part of the fixed electrode substrate, in order to electrically couple the movable electrode of the movable electrode substrate, and the adsorptive fixed electrode and the rotation controlling fixed electrode of the fixed electrode substrate, to the exterior of the light scanning mirror device.

5. The light scanning mirror device according to claim 1,
wherein the movable electrode substrate further comprises
a second movable electrode different from the movable electrode, provided in axial symmetry centering on the one axis, and
wherein the fixed electrode substrate further comprises
a second rotation controlling fixed electrode arranged oppositely to the second movable electrode.

6. The light scanning mirror device according to claim 1,
wherein an insulating film with protrusions is provided over at least one of the contacting surfaces of the cantilever movable electrode and the fixed electrode.

7. The light scanning mirror device according to claim 1,
wherein an element for measuring a rotation angle of the reflective mirror is built in a part of the reflective mirror.

8. A control method of the light scanning mirror device according to claim 1, the control method comprising the steps of:
applying a voltage between the cantilever movable electrode and the adsorptive fixed electrode to generate a static electricity power;
keeping the cantilever movable electrode in a state of being changeable from a narrow area on the side of the free end to a broad area on the side of the rotation controlling fixed electrode, by adsorbing and fixing the free end of the cantilever movable electrode to the adsorptive fixed electrode, by use of the static electricity power;
adsorbing the cantilever movable electrode to the rotation controlling fixed electrode, by changing gradually a voltage applied to the rotation controlling fixed electrode to generate an adsorption power; and
rotating the reflective mirror, by generating a torque to rotate the reflective mirror around the one axis by use of the adsorption power.

9. The control method of the light scanning mirror device according to claim 8,
wherein a laser light is scanned to draw an image, by rotating the reflective mirror in the state where the laser light is entered into the reflective mirror.

10. The control method of the light scanning mirror device according to claim 9,
wherein an element for measuring a rotation angle of the reflective mirror is built in a part of the reflective mirror, and a driver voltage applied to the fixed electrode is controlled according to an output of the element.

11. An image drawing device at least comprising:
a light source operable to emit a beam-shaped light; and
a reflective mirror operable to reflect the beam-shaped light emitted from the light source,
wherein the image drawing device draws an image by reflecting and scanning the beam-shaped light by use of the reflective mirror, and
wherein the light scanning mirror device according to one of claims 1 is employed as the reflective mirror.

12. An image drawing device at least comprising:
a light source operable to emit a beam-shaped light; and
a reflective mirror operable to reflect the beam-shaped light emitted from the light source,
wherein the image drawing device draws an image by reflecting and scanning the beam-shaped light by use of the reflective mirror, and
wherein the light scanning mirror device according to one of claims 2 is employed as the reflective mirror.

13. An image drawing device at least comprising:
a light source operable to emit a beam-shaped light; and
a reflective mirror operable to reflect the beam-shaped light emitted from the light source,
wherein the image drawing device draws an image by reflecting and scanning the beam-shaped light by use of the reflective mirror, and
wherein the light scanning mirror device according to one of claims 3 is employed as the reflective mirror.

14. An image drawing device at least comprising:
a light source operable to emit a beam-shaped light; and
a reflective mirror operable to reflect the beam-shaped light emitted from the light source,
wherein the image drawing device draws an image by reflecting and scanning the beam-shaped light by use of the reflective mirror, and
wherein the light scanning mirror device according to one of claims 4 is employed as the reflective mirror.

15. An image drawing device at least comprising:
a light source operable to emit a beam-shaped light; and
a reflective mirror operable to reflect the beam-shaped light emitted from the light source,
wherein the image drawing device draws an image by reflecting and scanning the beam-shaped light by use of the reflective mirror, and
wherein the light scanning mirror device according to one of claims 5 is employed as the reflective mirror.

16. An image drawing device at least comprising:
a light source operable to emit a beam-shaped light; and
a reflective mirror operable to reflect the beam-shaped light emitted from the light source,
wherein the image drawing device draws an image by reflecting and scanning the beam-shaped light by use of the reflective mirror, and
wherein the light scanning mirror device according to one of claims 6 is employed as the reflective mirror.

17. An image drawing device at least comprising:
a light source operable to emit a beam-shaped light; and
a reflective mirror operable to reflect the beam-shaped light emitted from the light source,
wherein the image drawing device draws an image by reflecting and scanning the beam-shaped light by use of the reflective mirror, and
wherein the light scanning mirror device according to one of claims 7 is employed as the reflective mirror.
